(19) United States
(12) Patent Application Publication
(10) Pub. No.: US 2007/0265960 A1
(43) Pub. Date: Nov. 15, 2007

(54) System and method for automated flexible person-to-person lending

(76) Inventors: Asheesh Advani, Dedham, MA (US); Grant C. Brown, Lowell, MA (US); Michael D. Michaud, Georgetown, MA (US); Andrew T. Michel, Cambridge, MA (US); Daniel M. Narahara, Reading, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/710,247

(22) Filed: Feb. 23, 2007

Related U.S. Application Data
(63) Continuation-in-part of application No. 11/431,422, filed on May 10, 2006.

(51) Int. Cl. G06Q 40/00

(52) U.S. Cl. 705/38

(57) ABSTRACT

A computer method for automating person-to-person lending comprises receiving from a user over a computer network at least one custom periodic payment amount for a loan period of a person-to-person loan; generating a custom loan schedule based on the custom amount; and transmitting the custom loan schedule over the computer network to the user. A further method comprises receiving from a first user over a computer network a request to modify at least one specific periodic payment amount for a loan period of a pre-existing person-to-person loan; receiving from a second user a consent to the first user's request; and generating a revised loan schedule for the loan based on the request to modify the payment amount. Another method comprises retrieving from a database loan history data for a person-to-person loan; and transmitting the loan history data to a credit reporting agency over a computer network.

### RELATED APPLICATION

This application is a continuation-in-part of U.S. application Ser. No. 11/431,422, filed May 10, 2006, the entire teachings of which are incorporated herein by reference.

### BACKGROUND OF THE INVENTION

Approximately 8% of U.S. households have a private loan outstanding to relatives and friends at any given point in time, according to the Federal Reserve Board's Survey of Consumer Finances. Person-to-person loans may be set up for a variety of reasons including for first or second mortgages, funding small businesses, and other personal financial needs. These person-to-person loans are often administered in an informal manner, resulting in high rates of late payment, default, and acrimony.

Accordingly, there is an ongoing need for automated techniques to facilitate management of person-to-person lending.

### SUMMARY OF THE INVENTION

In one embodiment according to the invention, there is provided a computer method for automating person-to-person lending. The method comprises receiving from a user over a computer network at least one custom periodic payment amount for a loan period of a person-to-person loan; generating a custom loan schedule based on the custom periodic payment amount; and transmitting the custom loan schedule over the computer network to the user.

In further, related embodiments, the custom periodic payment amount may comprise an increased, decreased, gifted, or moved periodic payment as compared with the corresponding periodic payment amount for a standard loan type. The custom periodic payment amount may be stored in a database associated with a server system receiving the custom periodic payment amount from the user. A full Promissory Note for the person-to-person loan may be generated based on the custom loan schedule; and the full Promissory Note may be transmitted over the computer network to the user. Data related to a proposed interest rate for the person-to-person loan may be received from the user; and information regarding legal interest rate guidelines may be provided based on the proposed interest rate. The method may also comprise monitoring adherence to payments required by the custom loan schedule; including recording payment status in a database associated with a server system receiving the custom periodic payment amount from the user; scheduling an electronic funds transfer to implement payments required by the custom loan schedule; and/or automatically transferring funds to a lender account.

In another embodiment according to the invention, a computer method for automating person-to-person lending comprises receiving from a user over a computer network at least one electronic inquiry regarding a person-to-person loan; and transmitting a comparison of information regarding a plurality of different possible loan types for the person-to-person loan to the user over the computer network. A set of user priorities for the person-to-person loan may be received from the user; and the comparison of information regarding the plurality of different possible loan types may be based on the user priorities.

In other related embodiments, the custom periodic payment amount may comprise a gift from a lender to a borrower of the person-to-person loan. The method may comprise receiving a gift amount from the user; determining actual interest paid, actual principal paid, and a total gift amount for the loan period based on the received gift amount; and providing to the user a report of the actual interest paid, actual principal paid, and total gift amount. The method may also comprise determining that the total gift amount exceeds a legal guideline; and providing to the user information regarding the exceeded legal guideline.

In another embodiment according to the invention, a computer method for automating person-to-person lending comprises receiving from a first user over a computer network a request to modify at least one specific periodic payment amount for a loan period of a pre-existing person-to-person loan; receiving from a second user a consent to the first user's request; and generating a revised loan schedule for the pre-existing person-to-person loan based on the request to modify the at least one specific periodic payment amount. The modified payment amount may comprise a gift from a lender to a borrower of the person-to-person loan; and the method may comprise receiving a gift amount for the modified payment amount; determining actual interest paid, actual principal paid, and a total gift amount for the loan period based on the received gift amount; and providing a report of the actual interest paid, actual principal paid, and total gift amount.

In another embodiment according to the invention, a computer method for automating person-to-person lending comprises retrieving from a database loan history data for a person-to-person loan; and transmitting the loan history data to a credit reporting agency over a computer network. The loan history data may comprise at least one of a party to the loan, an interest payment, a principal payment, and a due date. The loan history data may also comprise a payment status, such as received on time, late, or canceled. The loan history data may be converted into a format recognized by a credit reporting agency for institutional lenders, such as the METRO-2 data format. The loan history data may include data for a person-to-person loan comprising at least one of a modified specific payment, a custom specific payment, a gifted specific payment, a moved specific payment, or a modified loan term.

In a further embodiment according to the invention, a computer method for automating person-to-person lines of credit comprises receiving from a user over a computer network a request to create a person-to-person line of credit; and transmitting a schedule for the line of credit over the computer network to the user. A variable draw amount, or at least one variable payment amount, for the person-to-person line of credit may be received from the user. The line of credit may comprise an unsecured or secured line of credit, and may comprise a reverse mortgage.

In a further embodiment according to the invention, a computer method for automating person-to-person reverse mortgages comprises receiving from a user over a computer network a request to create a person-to-person reverse mortgage; and transmitting a schedule for the reverse mortgage over the computer network to the user. A loan-to-value (LTV) ratio for the reverse mortgage may exceed 100%. The method may further comprise receiving from the user over the computer network at least one custom periodic payment amount for a payment period of the reverse mortgage; generating a custom schedule based on the custom periodic payment amount; and transmitting the custom schedule over the computer network to the user. The method may also comprise receiving from the user over the computer network at least one of an age and a gender of at least one participant in the reverse mortgage or of the participant's spouse; determining a recommended loan duration for the reverse mortgage based on a mortality table using at least one of the age and the gender; and transmitting the recommended loan duration over the computer network to the user. The schedule may be based on a periodic cost-of-living adjustment, and/or a periodic home appreciation adjustment. The schedule may also include payment of third party loan fees, which may be due in an initial payment by at least one participant in the reverse mortgage; and/or may be due to be repaid with interest at the completion of the reverse mortgage; or may be due to be paid over a plurality of payment periods as part of payments in the payment periods. The method may also comprise transmitting to the user over the computer network at least one set of recommended loan terms based on pre-determined suggested loan-to-value (LTV) ratios.

Related computer systems and carrier media comprising computer readable code are also disclosed.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a block diagram of a conventional process flow for implementing person-to-person loans.

FIG. 1B is a block diagram of a process flow for automated flexible person-to-person loans, in accordance with an embodiment of the invention.

FIG. 2 shows a series of graphical user interfaces by which a user is enabled to specify a custom schedule for a person-to-person loan, in accordance with an embodiment of the invention.

FIG. 3 is a block diagram of a process implemented by a host server in response to a user's input for a custom person-to-person loan, in accordance with an embodiment of the invention.

FIG. 4 shows a series of graphical user interfaces by which a user may view or print a Promissory Note incorporating the custom terms that have been specified for a person-to-person loan, in accordance with an embodiment of the invention.

FIG. 5 is a block diagram of a process implemented by a host server in response to a user's input to view or print the Promissory Note for a custom person-to-person loan, in accordance with an embodiment of the invention.

FIG. 6 shows a series of graphical user interfaces by which a user is enabled to view comparative information about different loan options for structuring a person-to-person loan, in accordance with an embodiment of the invention.

FIG. 7 is a block diagram of a process implemented by a host server in response to a user's request for comparative information about different loan options for structuring a person-to-person loan, in accordance with an embodiment of the invention.

FIG. 8 shows a series of graphical user interfaces by which a user is enabled to view information regarding interest rate regulations and guidelines for structuring a person-to-person loan, in accordance with an embodiment of the invention.

FIG. 9 shows a series of graphical user interfaces by which a user is provided with loan servicing for a person-to-person loan containing non-standard loan terms, in accordance with an embodiment of the invention.

FIG. 10 is a block diagram of a process implemented by a host server to provide loan servicing for a person-to-person loan containing non-standard loan terms, in accordance with an embodiment of the invention.

FIG. 11 shows a graphical user interface and a related block diagram of processes implemented by a host server for converting specific due payments to gifts in a repayment schedule for a person-to-person loan, in accordance with an embodiment of the invention.

FIG. 12 is a further block diagram of processes implemented by a host server for converting specific due payments to gifts in a repayment schedule for a person-to-person loan, in accordance with an embodiment of the invention.

FIG. 13 shows a graphical user interface and a related block diagram of processes implemented by a host server for modifying specific payments in an existing repayment schedule for a person-to-person loan, in accordance with an embodiment of the invention.

FIG. 14 is a further block diagram of processes implemented by a host server for modifying specific payments in an existing repayment schedule for a person-to-person loan, in accordance with an embodiment of the invention.

FIG. 15 is a block diagram of a process implemented by a host server to report data regarding person-to-person loans to credit reporting agencies, in accordance with an embodiment of the invention.

FIG. 16A is a block diagram of a process implemented by a host server to convert data regarding person-to-person loans into an appropriate format for providing to credit reporting agencies, in accordance with an embodiment of the invention.

FIG. 16B is a block diagram of a process implemented by a host server to convert specific, flexible modifications to a person-to-person loan into an appropriate format for providing to credit reporting agencies, in accordance with an embodiment of the invention.

FIG. 17A shows a graphical user interface by which a user is provided with a basic mortgage calculator for a person-to-person reverse mortgage, in accordance with an embodiment of the invention.

FIG. 17B shows a graphical user interface by which a user is provided with an advanced mortgage calculator for a person-to-person reverse mortgage, in accordance with an embodiment of the invention.

FIG. 18A shows a graphical user interface by which a user is provided with loan summary and analysis for a person-to-person reverse mortgage, in accordance with an embodiment of the invention.

FIG. 18B shows a graphical user interface by which a user is provided with a repayment schedule for a person-to-person reverse mortgage, in accordance with an embodiment of the invention.

FIG. 19 illustrates a computer network or similar digital processing environment in which the present invention may be implemented.

FIG. 20 is a diagram of the internal structure of a computer (such as client processor/devices or server computers) in the computer system of FIG. 19.

### DETAILED DESCRIPTION OF THE INVENTION

Existing web-based services provide the ability to manage private person-to-person loans in an efficient manner. These services provide online promissory notes, electronic statements, payment collection (loan servicing), and other services to reduce the financial and emotional risks of person-to-person loans.

Embodiments according to the invention provide an improved loan servicing tool that automates the flexibility required to manage person-to-person loans by providing automated management of flexible repayment schedules, loan restructuring, and credit reporting for person-to-person loans. A first embodiment automates the creation and servicing of loans that contain unique repayment schedules. A second embodiment automates the flexible restructuring of private loans while maintaining the integrity of the original loan agreement or, where appropriate, replacing with a new agreement. A third embodiment provides the automated ability to perform credit reporting on potentially unique and restructured private loans. Other related embodiments are discussed herein.

In a first embodiment according to the invention, there is provided an automated process whereby two parties can agree to repayment terms for a person-to-person loan that uniquely suit their needs. Conventional loans with financial institutions and private lenders typically have set repayment schedules. The most common payment schedules are “Interest-only with Balloon Payments” and “Amortized.” There are other, less widely used, but still not unique payment schedules such as “Graduated,” “Fixed with Balloon,” and “Interest-Only then Amortized.” The first embodiment according to the invention offers private lenders the ability to customize the loan repayment schedule for person-to-person loans into whatever form the two parties agree upon. Such repayment schedules are predefined, but unique. For example, payments may change month to month depending on the financial means of the parties. As another example, schedules may be seasonal in nature, with payments rising for a subset of the year in recognition of additional income being available to the borrower during those times of the year; or schedules may contain regular large lump payments offsetting small regular payments, such as where additional money is provided at the end of each quarter. In order to be a loan and not a gift, interest accrues throughout the loan period, but the payments can be made in whatever unique schedule suits the two parties.

In order to facilitate creation of fully custom payment schedules, an embodiment according to the invention includes a facility allowing the user to model different loan terms, creating a repayment schedule that best suits the financial constraints of both parties. In addition, certain payments may be forgiven as a gift from the lender to the borrower if the parties so choose. Because of the close nature of relationships between relatives and friends, the ability to make gifts and track them in an automated manner is an attractive feature of an embodiment according to the invention. For example, individuals may be enabled to make automated mortgage loans to their relatives and to gift a portion of the loan principal every year; while at the same time being enabled to maintain compliance with IRS regulations, and being provided with a loan calculator, statements to be used for tax purposes, and payment processing services to enable these transactions to take place. In accordance with an embodiment of the invention, payment processing services include the automated ability to request servicing of loans with unique terms; to view the loan schedule online, including updates due to missed payments, overpayments, underpayments, delayed payments and gifted payments; and to provide statements to be used for tax purposes covering annual interest paid.

A second embodiment according to the invention allows parties in a private loan to modify the loan repayment in an automated fashion while preserving the legal agreement between the parties or, in some cases, while modifying the agreement. A promissory note is generated for the loans between the parties. The promissory note is the basis for the legal, binding agreement between the parties. The second embodiment provides the unique ability to automatically restructure the loan while it is in process, while preserving the terms. Using a web browser, the parties may update the repayment schedule, as long as both parties agree to the modifications being made. Parties may agree to modifications that require no changes to the promissory note, such as a permanent or temporary change of due date, a permanent or temporary change of transaction date, putting a repayment schedule “on hold” for a period of time, making up a past due or missed payment, or making an additional principal payment. Parties may also agree to modifications that require an addendum to the promissory note, such as changes to the late fee or grace period of a note, changes to the individual payment amounts (but not the overall principal repaid), or extending the term of the loan. Parties may also agree to modifications that require either an addendum to the promissory note, or, potentially, an entirely new agreement between the parties, such as a change of principal amount, a change of interest rate, or a change to the loan parties. When changes require an addendum to the promissory note, the addendum may be generated immediately through the same web browser interface used to specify the changes.

A third embodiment according to the invention provides credit reporting on flexible, person-to-person loans. Histories of loan repayment made through financial institutions has long been reported to the credit reporting system, which is composed of data repositories licensed by the U.S. Federal Government as credit reporting agencies. The third embodiment according to the invention combines the flexibility of the first and second embodiments, both in terms of the payment schedules and the ability to modify or restructure the loan, with the ability to report on the borrower's history of payments against the terms of the loan. The third embodiment is particularly useful in cases where a borrower is unable to fulfill the original terms of the loan, but repayment changes are agreed upon between the borrower and the lender, resulting in a new payment schedule that allows for credit reporting that reflects positively on the borrower. The third embodiment includes a set of automated business processes and protocols for reporting restructured person-to-person loans to the credit reporting system. This includes a process of converting data into an appropriate format for submission to the credit reporting system that acknowledges that the loan has been restructured and that the payment is not late or missed, thereby avoiding a negative mark on the borrower's credit report.

A fourth embodiment according to the invention provides automated techniques for implementing and supporting person-to-person lines of credit, which have not previously been supported. Such an embodiment may also combine the flexibility of the other embodiments with its support of automated person-to-person lines of credit.

A fifth embodiment according to the invention provides tools for automating person-to-person reverse mortgages, as discussed further below.

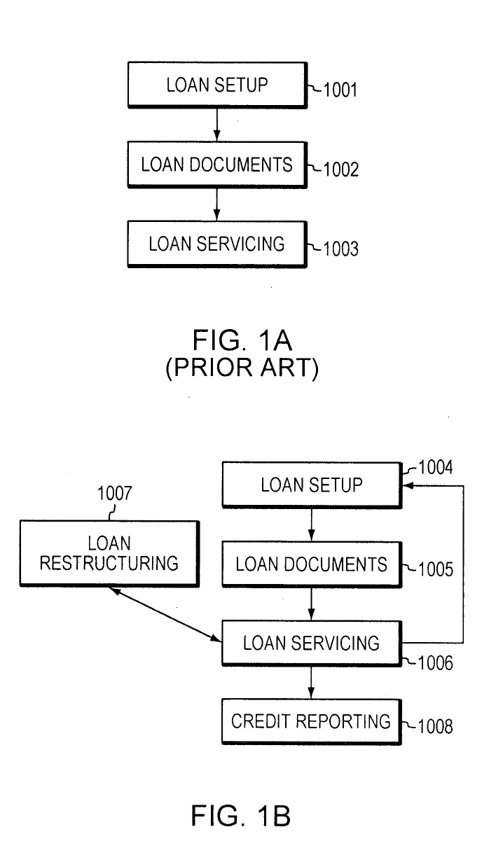

FIG. 1B is a block diagram of a process flow for automated flexible person-to-person loans in accordance with an embodiment of the invention, as opposed to the conventional process flow of FIG. 1A. The conventional process of FIG. 1A involves loan setup 1001, loan documentation 1002, and loan servicing 1003. In the conventional process, private loans can be modified informally by the parties involved; but there is no automated, computer-based system allowing for the flexibility that users desire; nor is there any existing mechanism to provide data concerning private loans to credit reporting agencies. By contrast, in the embodiment according to the invention of FIG. 1B, loan setup 1004, loan documentation 1005, and loan servicing 1006 can be augmented by automated flexible loan restructuring 1007 and credit reporting 1008 in person-to-person loans.

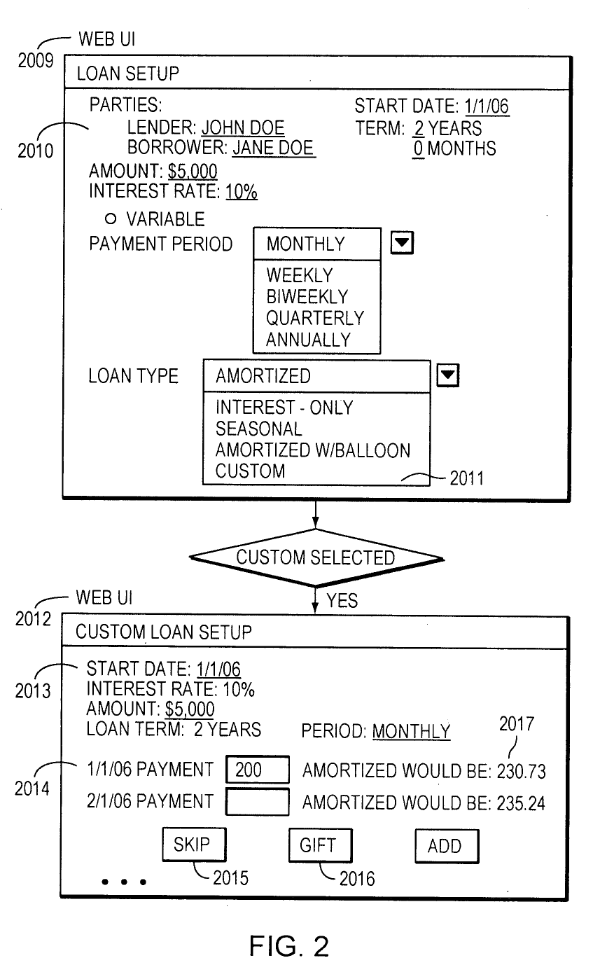

As discussed above, in accordance with a first embodiment of the invention, users of the system are allowed to specify loan terms that do not conform to any standard loan schedules. In addition to using standard schedules, the system provides a web browser-based interface for users to set up person-to-person loans according to any terms or schedules they would like. FIG. 2 shows a series of graphical user interfaces by which a user is enabled to specify a custom schedule for a person-to-person loan, in accordance with an embodiment of the invention. In a first loan setup user interface 2009, a user is presented with a loan's terms 2010, such as the parties, amount, interest rate, start date, term, payment period, and loan type. Upon the user's selection of the “custom” loan type 2011, the system presents the user with a custom loan setup user interface 2012. In addition to showing the terms 2013 of the custom loan, such as the start date, interest rate, amount, term, and period, the custom interface 2012 allows the user to select a specific payment amount desired for the first payment 2014. Alternatively, through the use of buttons (or other user interface objects) on the screen, the user can specify that they would like to skip 2015 or gift 2016 a payment. The system also displays the recommended payment amount 2017 based on the remainder of the loan being calculated as a standard amortized loan.

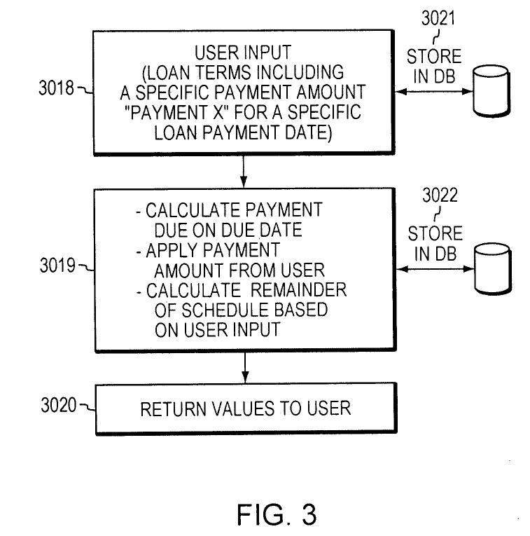

FIG. 3 is a block diagram of a process implemented by a host server in response to a user's input for a custom person-to-person loan, in accordance with an embodiment of the invention. Through web browser functionality, the user selections of FIG. 2 for the custom loan are communicated to the back end host server system. The back end system accepts the user input 3018 of the custom loan terms, such as a specific payment amount for a specific loan payment date, and stores them 3021 in a database associated with the back end system. The back end system then uses 3019 the user input to calculate the principal and interest paid through the payment date being modified, apply the payment amount specified by the user to the schedule, and calculate the recommended future payments to fulfill the terms of the loan. The back end system stores 3022 the user selections along with the calculated amounts in a database for later retrieval. The back end system then returns 3020 the results to the user for display in the web browser. The user could, optionally, go through the entire series of loan payments and modify each one. The back end system captures these modifications for later use in the loan documentation, loan servicing and/or viewing by the user.

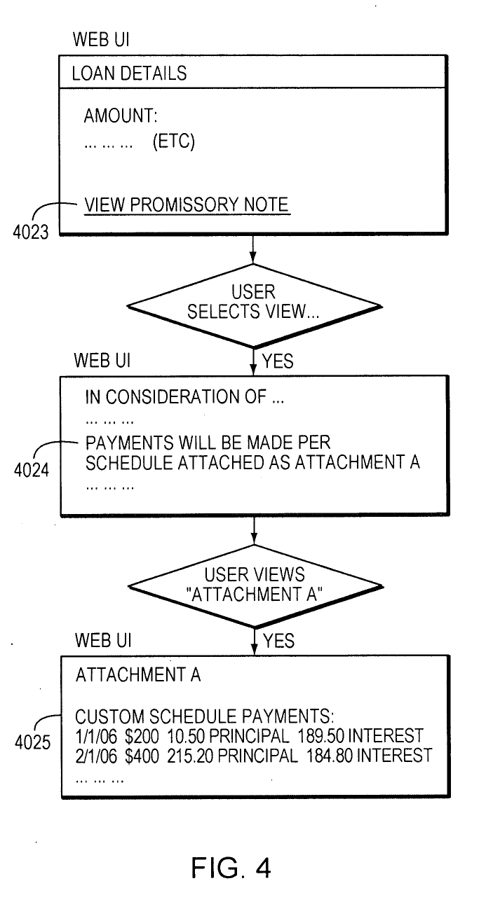

FIG. 4 shows a series of graphical user interfaces by which a user may view or print a Promissory Note incorporating the custom terms that have been specified for a person-to-person loan, in accordance with an embodiment of the invention. If the user wishes to view the Promissory Note, the user selects the “View Promissory Note” option 4023, and is presented with a graphical user interface 4024 showing the terms of the Promissory Note with an option of selecting to view the payment schedule, which may be presented as in graphical user interface 4025. The graphical user interfaces 4024 and 4025 display the entire loan document, including the details of the standard and non-standard terms, which may be viewed and printed.

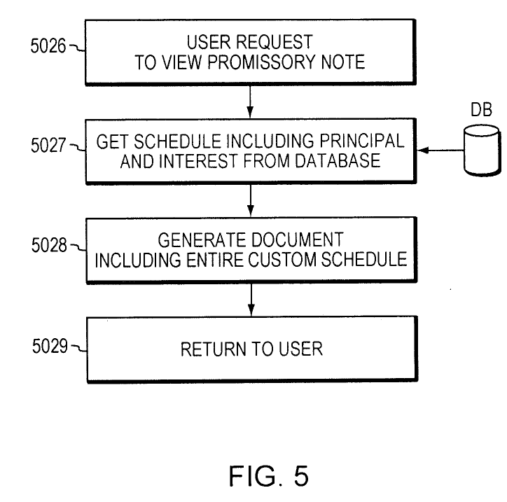

FIG. 5 is a block diagram of a process implemented by a host server in response to a user's input to view or print the Promissory Note for a custom person-to-person loan, in accordance with an embodiment of the invention. Upon receiving 5026 a user request to view the Promissory Note, such as from the graphical user interface of FIG. 4, the back end host server system retrieves 5027 the loan schedule and other custom data, including the principal and interest figures, that were stored 3022 (FIG. 3) in the database during calculation of the custom loan terms. The back end system then generates 5028 appropriate documents setting forth the entire Promissory Note, based on the stored loan schedule, and returns the documents 5029 to the user, such as via internet protocols for display in the user's web browser.

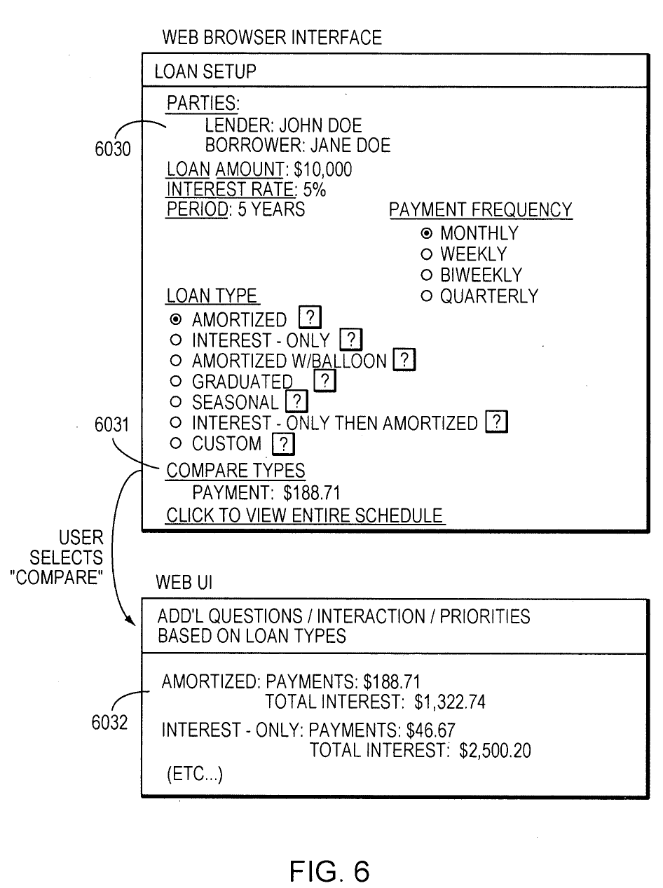

FIG. 6 shows a series of graphical user interfaces by which a user is enabled to view comparative information about different loan options for structuring a person-to-person loan, in accordance with an embodiment of the invention. Such an interface allows users to consider various loan types when creating their private loan, and to make informed decisions about the various options available to them. In a first graphical user interface 6030, a user is given the option 6031 of comparing various types of loans. Upon the user's selecting the compare option 6031, additional graphical user interfaces may be presented asking the user a series of questions about the user's constraints, flexibility, and priorities. For example, one user may desire to pay back a loan with the top priority being to pay as little interest as possible, while another user may wish to pay back the loan with the top priority being to pay it back as quickly as possible. After the back end system has processed the user's input, the user is presented with a graphical user interface 6032 providing comparative information about the available loan options, such as schedule comparisons or a comparison of payments and total interest.

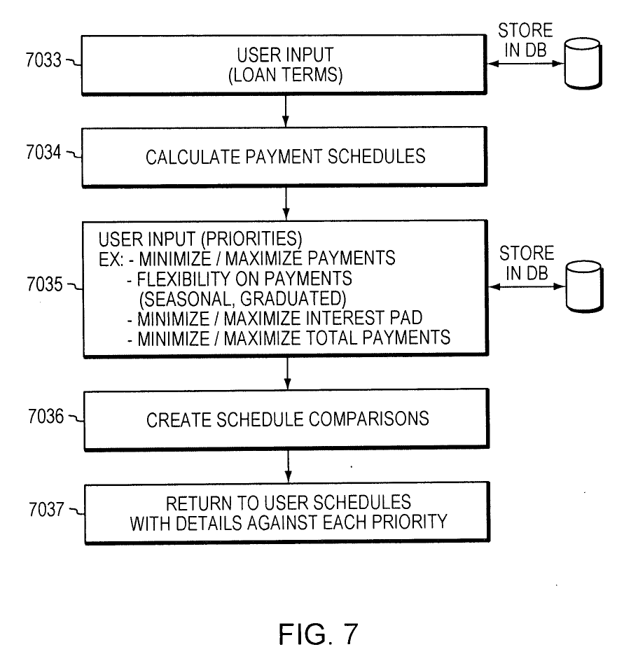

FIG. 7 is a block diagram of a process implemented by a host server in response to a user's request for comparative information about different loan options for structuring a person-to-person loan, in accordance with an embodiment of the invention. Once the user's input of loan terms 7033 has been received, such as using internet protocols via a web browser interface, the back end host server stores the terms in a database, and calculates 7034 payment schedules under various possible loan types. Next, the back end system receives 7035 the user's input of loan priorities, after the user has selected the compare option 6031 of FIG. 6, and stores the priorities in a database. For example, the system may receive user priorities as to the degree of minimizing or maximizing payments, the degree of flexibility on payments (e.g. seasonal or graduated), the degree of minimizing or maximizing interest paid, and the degree of minimizing or maximizing total payments. Having received the user's priorities, the back end system creates 7036 comparative data, such as schedule comparisons for various model loans (including standard and nonstandard loan types), and returns the comparative data 7037 to the user with details provided against each user priority. For example, in the graphical user interface 6032 of FIG. 6, the user may be provided with data as to the monthly payment amount and total interest amount, where the user has expressed priorities for those criteria. The system thereby provides insight into the loan terms that best suit the user's preferences and financial model.

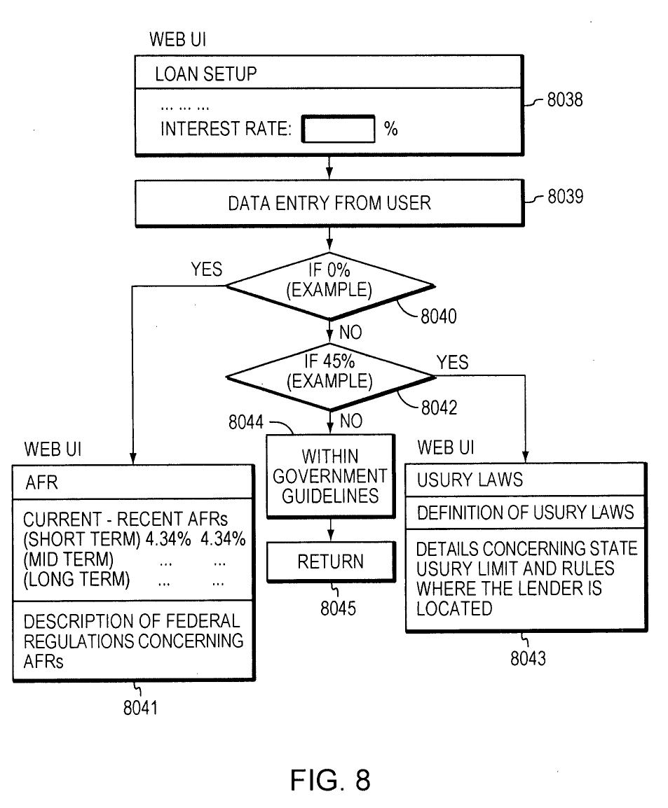

FIG. 8 shows a series of graphical user interfaces by which a user is enabled to view information regarding interest rate regulations and guidelines for structuring a person-to-person loan, in accordance with an embodiment of the invention. In a graphical user interface 8038, a user enters data 8039 specifying, for example, the interest rate for the loan. If the interest rate is below the current Applicable Federal Rate (AFR) 8040, the user is presented with a graphical user interface 8041 providing information about the current AFR and related regulations. Because the Federal Government updates the AFR on a regular basis, a back end host server updates the interest rate triggering display of the interface 8041, and any changed information to be presented in the interface 8041. On the other hand, if the interest rate 8042 is above what is considered usury in the lender's location (such as in the lender's city or state), the user is presented with a graphical user interface 8043 providing information about local laws and regulations regarding usury. If the interest rate is within legal guidelines 8044, the user is returned to graphical user interface 8038. The graphical user interfaces of FIG. 8 may implemented by a back end host server to which user input is communicated over a network protocol, such as via a web browser over the internet.

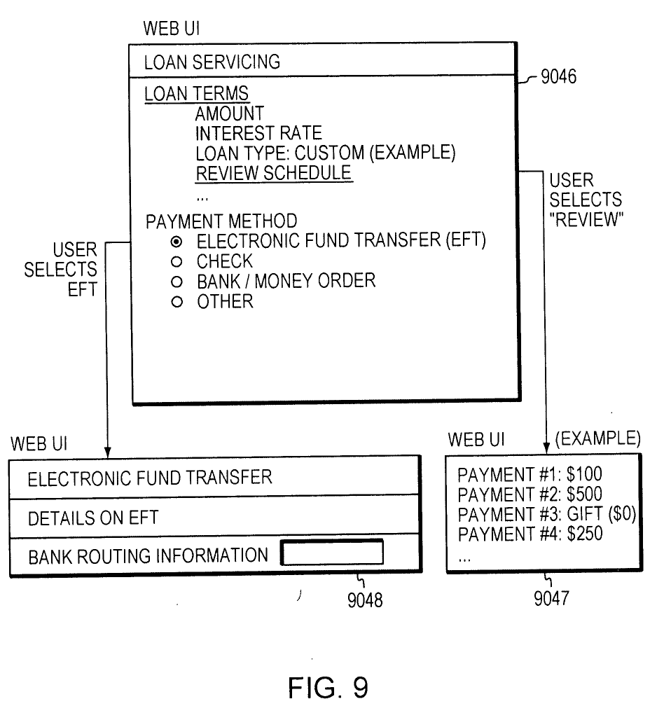

FIG. 9 shows a series of graphical user interfaces by which a user is provided with loan servicing for a person-to-person loan containing non-standard loan terms, in accordance with an embodiment of the invention. If the user selects on graphical user interface 9046 to review the schedule of the person-to-person loan, the user is presented with a graphical user interface 9047 showing the schedule of payments based on the non-standard loan terms. Graphical user interface 9046 also allows the user to select the type of payment (such as Electronic Funds Transfer, check, or money order) to use when making payments against the terms of the non-standard loan. Additional graphical user interfaces 9048 may be used to collect information from the user concerning the bank account to be used for an Electronic Funds Transfer, or to collect other specific payment information.

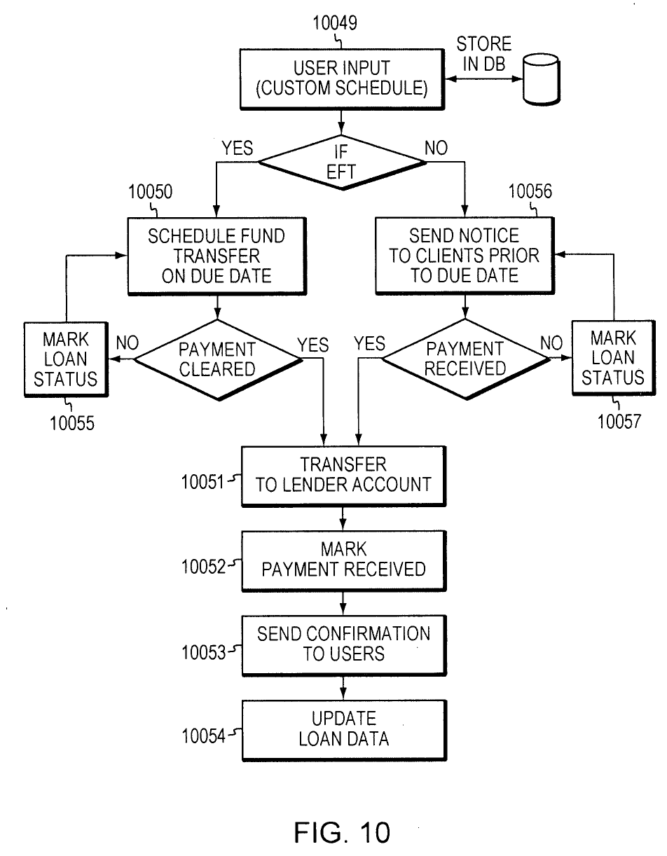

FIG. 10 is a block diagram of a process implemented by a host server to provide loan servicing for a person-to-person loan containing non-standard loan terms, in accordance with an embodiment of the invention. The back end host server receives 10049 user input of a custom loan schedule, and stores the custom schedule in a database. The system then processes the payments as expected in the payment schedule attached to the loan terms. Upon receiving user input that an Electronic Funds Transfer is to be used for payment, such as via graphical user interface 9046 of FIG. 9, the back end system sets up automated processing with the bank involved, and schedules 10050 an Electronic Funds Transfer on the payment due date. If the payment clears, the system transfers 10051 funds to the lender account, electronically marks the payment as received 10052, sends confirmation 10053 to the users, and updates the loan data 10054. However, if the payment for the Electronic Funds Transfer does not clear, the back end system marks the loan status accordingly 10055 in the database, and may automatically take appropriate action, or notify an agent to do so. If, on the other hand, the user does not elect to use Electronic Funds Transfer, such as via graphical user interface 9046 of FIG. 9, the back end system updates the user information in the database to reflect other payment methods, and automatically sends 10056 notice to the clients of the payment due, prior to the due date. If the payment is received, the payment is electronically marked in the system as received 10052, and the back end system sends confirmation 10053 to the users and updates the loan data 10054; but if the payment is not received in time, the back end system marks the loan status accordingly 10057 in the database, and may automatically take appropriate action, or notify an agent to do so.

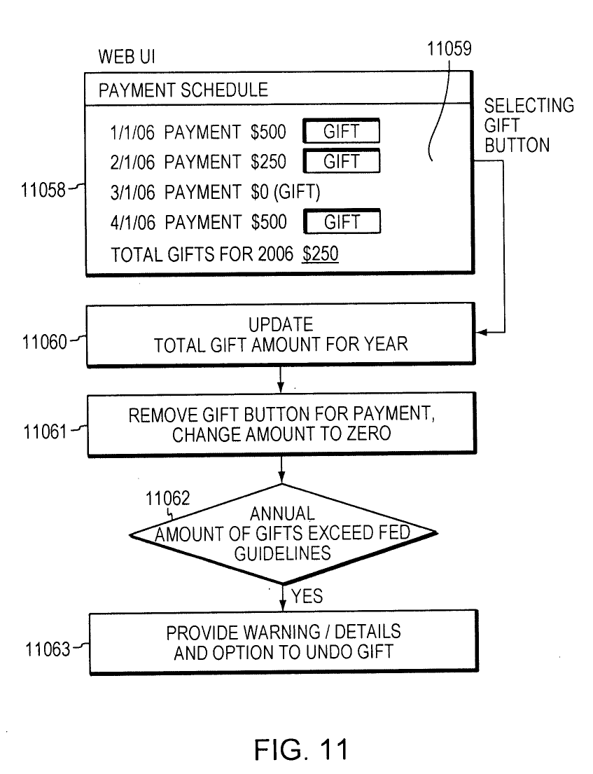

FIG. 11 shows a graphical user interface and a related block diagram of processes implemented by a host server for converting specific due payments to gifts in a repayment schedule for a person-to-person loan, in accordance with an embodiment of the invention. Such a technique may be implemented in accordance with any of the embodiments described herein, including for a pre-existing person-to-person loan or for a loan that is in the process of being created or modified. Gifts, in the context of a private loan, may include payments that are forgiven or principal that is forgiven, resulting in a new repayment schedule and/or new total payments expected to repay the loan. A decision to convert a payment or part of the principal to a gift must be made or confirmed by the lender. In the graphical user interface 11058 of FIG. 11, a user may view the schedule of payments for a person-to-person loan, which may be either pre-existing or be in the process of being set up. The user may select a “Gift” button 11059 next to certain payments that the user would like to convert to gifts. Upon the user's selection to make a given payment into a gift, a back end host server then updates 11060 the user's total gift amount for the year in the database, and displays the new total gift amount on the graphical user interface 11058. The back end system also causes the “Gift” button next to the selected payment to be removed 11061 and changes the payment amount for that due date to be zero. If the user's total amount of gifts for the year exceeds 11062 legal guidelines (such as Federal tax guidelines), the back end system may cause the interface 11058 to display a warning and details regarding gift guidelines, and an option for the user to undo the gift. The graphical user interface 11058 may display a total gift amount for the year or the life of the loan, which may be updated as new payments are gifted. The user may also have the option to undo a previous change to a payment that was turned into a gift.

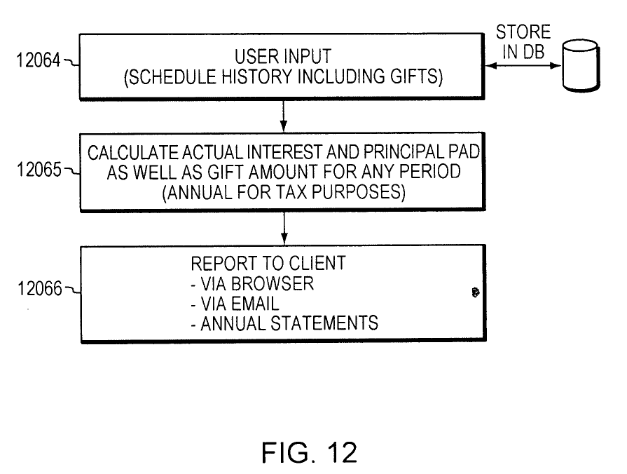

FIG. 12 is a further block diagram of processes implemented by a host server for converting specific due payments to gifts in a repayment schedule for a person-to-person loan, in accordance with an embodiment of the invention. The back end host server system accepts 12064 the modification to the schedule from the client, for example via the graphical user interface 11058 of FIG. 11, and stores the modification as information about the loan in the database. When the system processes a request to provide total interest and principal paid for any period (annually for example when clients are considering tax implications), the system may calculate 12065 and provide to the user 12066 the actual amount of interest and principal paid, exclusive of payments that were gifted. The data could be provided 12066 in any number of standard formats, such as via a web browser, via email, or printed in an annual statement.

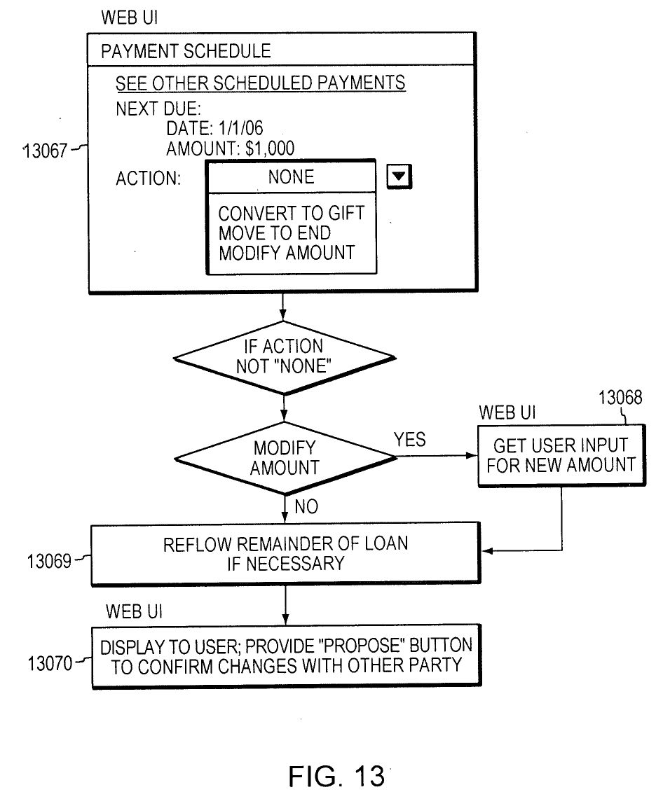

FIG. 13 shows a graphical user interface and a related block diagram of processes implemented by a host server for modifying specific payments in an existing repayment schedule for a person-to-person loan, in accordance with the second embodiment of the invention. In graphical user interface 13067, the user is able to select a specific payment in a schedule, and an action to take against that payment. For example, the user may wish to convert a payment to a gift, move the payment to the end of the loan term, or modify the amount of the specific payment. If the user elects to modify the amount of the specific payment, the system presents 13068 a graphical user interface requesting user input of the new amount for the payment, which the user may set to be any particular amount, from $0 to the outstanding balance of the loan. If the user elects another modification, the system may reflow 13069 the remainder of the loan if necessary. If the user elects to make any modifications to a specific payment, the system notifies 13070 the user that both parties in the loan must agree to changes in terms, and may provide a “Propose” button on a graphical user interface to confirm any changes with the other party to the loan.

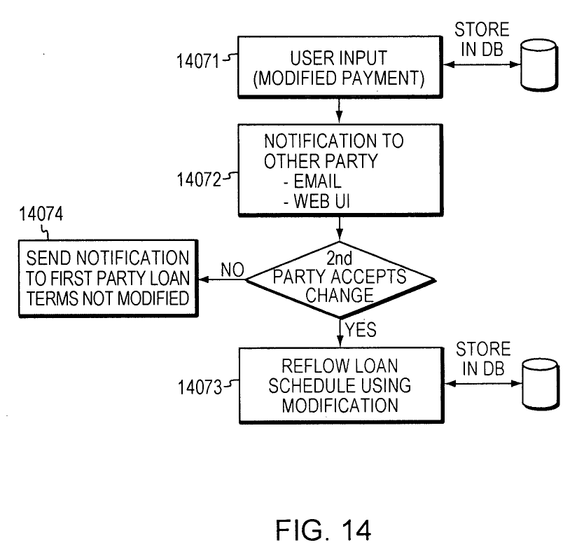

FIG. 14 is a further block diagram of processes implemented by a host server for modifying specific payments in an existing repayment schedule for a person-to-person loan, in accordance with an embodiment of the invention.

The back end host server system accepts 14071 the user request to modify the specific payment, stores data for the request in the database, and sends 14072 notification to the other party. This notification may be by a number of possible methods, including by e-mail, by a web or other graphical user interface, or by notifying a person to send physical mail containing the notification. The other party to the loan is given an opportunity to agree or disagree with any modifications. If the other party agrees to the modifications, the back end system accepts the change and updates the payment to reflect the new amount to be processed. Further, the back end system updates 14073 the remaining payments in the repayment schedule, if it is necessary to do so in order to process the change while continuing to have the overall repayment schedule meet the terms of the loan agreed by the parties. If the other party does not agree to the modifications, the system may cause an automated notification to be sent 14074 to the party who requested the modification, indicating that the proposed terms were not accepted.

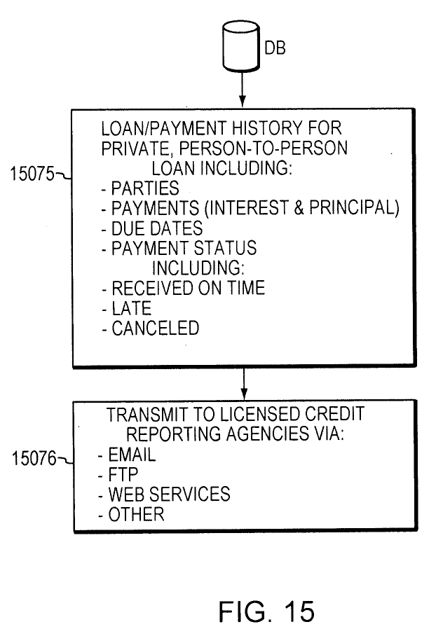

FIG. 15 is a block diagram of a process implemented by a host server to report data regarding person-to-person loans to credit reporting agencies, in accordance with the third embodiment of the invention. A back end host server system collects information 15075 from its database about the loan and payment history of current private loans being serviced, and transmits 15076 the data to credit reporting agencies. The collected data may include loan and payment histories, the parties, interest and principal payments, due dates, and the status of a payment (such as Received on Time, Late, or Canceled). The data may be transmitted using any number of methods including e-mail, FTP, or web services.

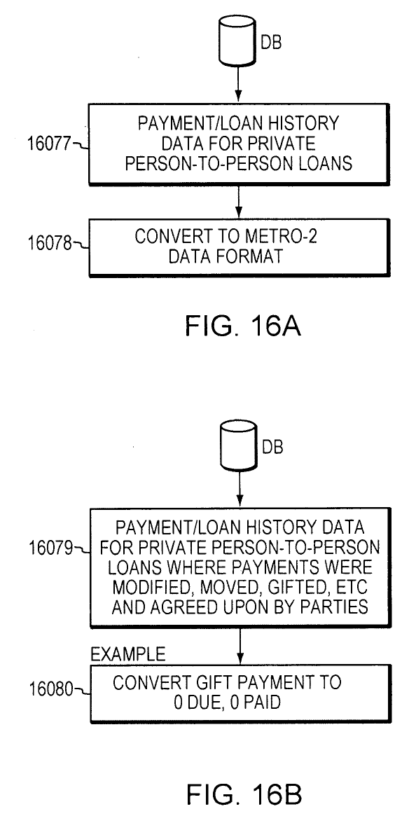

FIG. 16A is a block diagram of a process implemented by a host server to convert data regarding person-to-person loans into an appropriate format for providing to credit reporting agencies, in accordance with the third embodiment of the invention. In this embodiment, a back end host server system collects 16077 payment and loan history data for a person-to-person loan from its associated database, and maps 16078 the payment and loan history data into an appropriate format for providing to credit reporting agencies. In one embodiment, the appropriate format is the METRO-2 data format, which is a data format designed for use by institutional lenders in credit reporting. The mapping 16078 may map the internal loan status signifiers used by the back end server into the status signifiers used by the METRO-2 format. For example, some mappings that may be used in an embodiment of the invention include:

1) A Creditor Classification field in the METRO-2 format could be implemented as “Personal Services,” for the person-to-person loan. Note that the Creditor Classification field in the METRO-2 format supports classifications such as Retail, Utilities, Credit Union, etc.

2) An ECOA Code (Equal Credit Opportunity Act) field in the METRO-2 format could be implemented as “Undesignated,” for the person-to-person loan, since the lenders in private loans are not credit institutions and are not regulated by the Act.

3) A Creditor Name field in the METRO-2 format could be left blank to accommodate the fact that credit reporting agencies are not able to handle a volume of reports on individual private lenders.

FIG. 16B is a block diagram of a process implemented by a host server to convert specific, flexible modifications to a person-to-person loan into an appropriate format for providing to credit reporting agencies, in accordance with the third embodiment of the invention. This embodiment provides the ability to convert the flexibility for person-to-person loans, inherent in embodiments described herein, into terms acceptable by credit reporting agencies. Specific, flexible actions taken on a loan are converted into standard credit reporting terms. For example, a back end host server system may obtain 16079 from its associated database the payment and loan history data for a person-to-person loan, where the loan parties have agree to modify, move, gift, or otherwise flexibly modify the payments in accordance with embodiments herein. In order to reflect such a flexible change within the standard credit reporting system, the back end system may, for example, convert 16080 the reporting for a payment that has been gifted into an on-time payment of $0 due and $0 paid. The back end system then reports the $0 payment to credit reporting agencies. Other examples of providing credit reporting of flexible person-to-person loans in accordance with an embodiment of the invention include the following, each of which assumes approval by both the lender and the borrower:

1) For a mortgage between two private parties where the lender decides to forgive the remaining principal on the mortgage, the back end system may report this as the loan being completed to the lender's satisfaction.

2) For a payment being moved to the end of the payment schedule, skipping a payment period, the back end system may report this to credit reporting agencies as $0 due and $0 paid with the same principal balance outstanding.

3) For a loan being put on “Hold”, suspending payments for an agreed upon period, the back end system may report this to credit reporting agencies as $0 due and $0 paid with the same principal balance outstanding.

This type of conversion is necessary for person-to-person loans containing the flexibility inherent in embodiments described herein because there is no support for the concepts of forgiven principal, gifted payments, or modified payments in the present credit reporting agency systems.

In a fourth embodiment according to the invention, there is provided a technique for automating person-to-person lines of credit, which have not previously been supported. Such techniques may make use of similar methods, systems, and carrier media as are described in other embodiments herein, including using broadly similar interactions between a user and a back end host server system via graphical user interfaces. In this embodiment, however, instead of (or in addition to) automating person-to-person loans, the system supports automated set-up and servicing of person-to-person lines of credit. Such lines of credit may, for example, consist of flexible and variable draws and/or payment schedules, and may be secured or unsecured. In one example, there is provided a technique for automating person-to-person reverse mortgages that are implemented as lines of credit. In this case, the lender is scheduled to make specific periodic contributions (draw), while the borrower uses their home equity (or a portion of their home equity) as security. Such a reverse mortgage may or may not have a repayment schedule; for example, a lump sum payment could be scheduled for 30 years from the set-up of the reverse mortgage. Such automated techniques for automated person-to-person lines of credit may be combined with any of the other embodiments described herein.

A fifth embodiment according to the invention provides tools for automating person-to-person reverse mortgages. As used herein, a “reverse mortgage” is a loan or line of credit, secured by a home, in which the home owner has no obligation to repay the loan or line of credit until the home is sold or the borrower dies.

Existing web-based reverse mortgage calculators do not enable person-to-person reverse mortgages. Instead, they typically provide information related to institutional and Federal reverse mortgage programs. For example, existing mortgage calculators may provide comparisons of maximum legal loan amounts, interest rates, and periodic disbursements, based on pre-existing Federal and institutional reverse mortgage programs.

By contrast, a fifth embodiment according to the invention provides a number of tools for automating person-to-person reverse mortgages. Users are provided with tools for modeling and comparing loan terms for person-to-person reverse mortgages, and may be enabled to execute promissory notes for person-to-person reverse mortgages in an automated fashion. As an example of a person-to-person reverse mortgage, an operator of an embodiment according to the invention may act as an intermediary between a parent (the borrower) and his or her child (the lender), who makes monthly payments to the parent. In return, the child gradually gains equity in the parent's home. The intermediary is paid loan fees, arranges for the set-up and administration of the loan, and may transfer funds from the lender to the borrower.

Because existing Federal and institutional reverse mortgage programs are regulated, existing reverse mortgages are limited to certain loan-to-value ratios, under which the ratio of the amount of the loan to the value of the borrower's home cannot exceed a certain ratio, such as 70% or another pre-specified percentage. By contrast, because the fifth embodiment enables person-to-person reverse mortgages, it is not subject to the same regulations and allows individuals to arrange for a person-to-person reverse mortgage in which the loan-to-value ratio takes on a wide range of possible values, including exceeding a 100% loan-to-value ratio.

In addition, by combining the fifth embodiment with the features of other embodiments discussed herein, person-to-person reverse mortgages may be implemented with the flexibility of unique schedules and repayment terms. Thus, individuals may arrange for gifts and other unique and flexible repayment schedules, in a similar fashion to that discussed for other embodiments herein, for a person-to-person reverse mortgage in an automated fashion. For example, a child may give a parent an initial, larger lump sum, followed by later regular payments of smaller amounts; or may simply give a series of regular payments of equal amount. Also, individuals may be enabled to execute a promissory note for a person-to-person reverse mortgage, in a similar fashion to other automated promissory notes described for other embodiments herein.

The fifth embodiment also automates the determination of recommended loan durations (sometimes known as “planning horizons”) based on standard mortality tables and the ages and genders of participants. After a user has input the age and gender of the borrower and/or his or her spouse, the back end server accesses a mortality table, which may be implemented, for example, as a look-up table in a database stored on a server and may be based on known industry mortality tables. Using resulting estimates of mortality rates in the years following the borrower's (and/or his or her spouse's) current age (taking into account the effect of gender on the mortality table), the back end server then determines a recommended loan duration. The determination may be made, for example, by comparing a pre-specified mortality probability limit with the age range at which that probability is found for the borrower's age group and gender (for example, at a 25% mortality probability for the borrower's age group and gender the loan duration should be recommended to end). Using this recommended loan duration, the fifth embodiment may automatically provide a variety of recommended loan options for a person-to-person reverse mortgage. Such a mortgage calculator provides benefits to both the borrower and lender, such as that the borrower is less likely to outlive his or her income stream and the lender can determine a prudent maximum payment amount.

Further, the fifth embodiment allows the automated creation of flexible loan structures that are suited to loans between individuals, as opposed to loans between individuals and institutions. For example, the fifth embodiment allows the generation of unique loan schedules for person-to-person reverse mortgages that incorporate yearly cost-of-living adjustments, and unique loan schedules that incorporate yearly home appreciation adjustments.

In addition, the fifth embodiment allows the generation of recommended maximums and repayment schedules for a person-to-person reverse mortgage based on a wide range of interest rates. Also, the fifth embodiment allows the determination of flexible arrangements for the repayment of third party loan fees, such as by: 1) upfront payment by either loan constituent; 2) adding the upfront third party fees to the loan total, to be repaid with interest at the completion of the loan; 3) absorbing the third party loan fees over a set period of time by the borrower as components of payments; 4) splitting the fees between the loan constituents; or some other flexible arrangement.

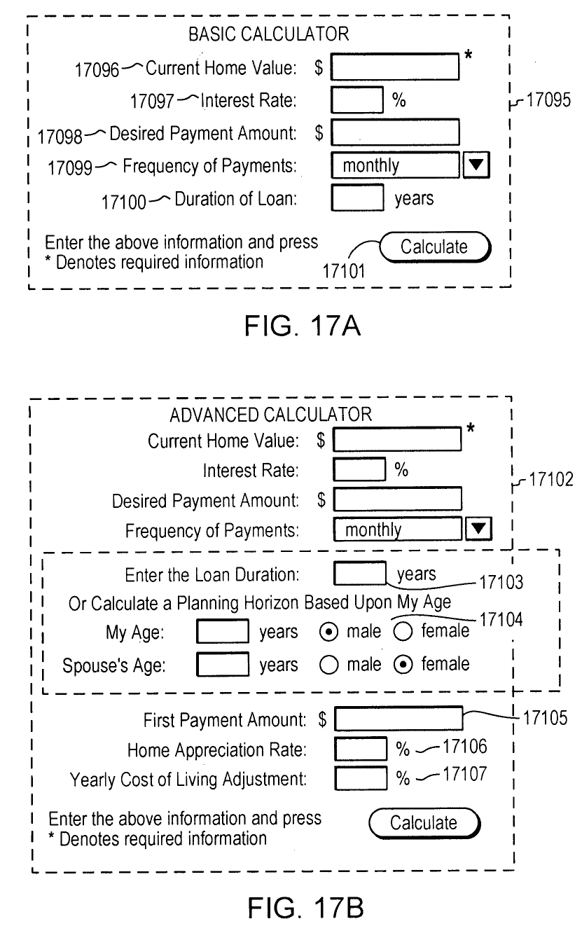

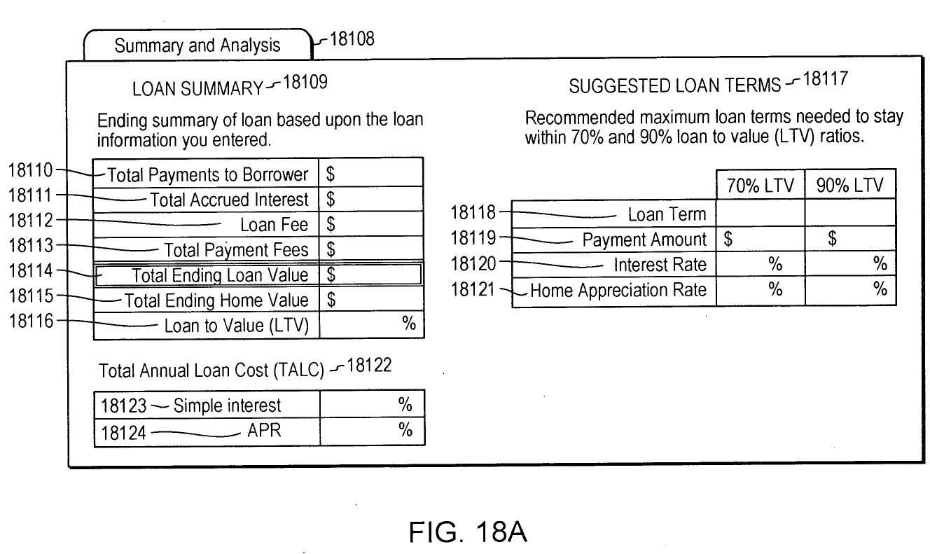

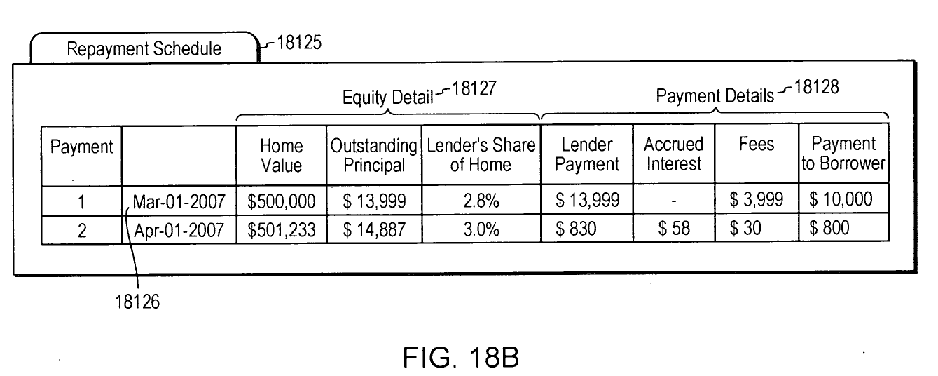

FIG. 17A shows a graphical user interface by which a user is provided with a basic mortgage calculator 17095 for a person-to-person reverse mortgage, in accordance with an embodiment of the invention. The user may input a current home value 17096, which is the only mandatory field for the user to enter in the embodiment of FIG. 17A. In addition, the user may input a desired interest rate 17097, desired payment amount 17098, desired frequency of payments 17099, and desired duration of loan 17100. Once the user presses the calculate button 17101, the back end server determines recommended loan terms and other loan summary information as shown in FIGS. 18A and 18B, based on the user's input data. If the user has not input a desired interest rate 17097 and duration of loan 17100, the back end server uses suggested default values for the interest rate and duration of the loan, along with the user's input home value 17096, to determine the recommended loan terms. Otherwise, the determination is based on the user's input home value 17096, interest rate 17097 and duration of loan 17100.

FIG. 17B shows a graphical user interface by which a user is provided with an advanced mortgage calculator 17102 for a person-to-person reverse mortgage, in accordance with an embodiment of the invention. The advanced calculator 17102 includes additional fields as compared with the basic calculator 17095, for users who desire additional modeling. The advanced mortgage calculator 17102 may use either of two interface formats to determine loan duration: either request a user's desired loan duration as at 17103; or allow the user to input his or her age and gender, and his or her spouse's age and gender, as at 17104, so that the back end server can determine a planning horizon based on a mortality table as described above. In addition, the advanced mortgage calculator 17102 may allow the user to enter a first payment amount 17105 that is greater than subsequent payments; and to enter a home appreciation rate 17106 and yearly cost of living adjustment 17107 that will be taken into account in performing the back end reverse mortgage determinations.

It should be appreciated that the graphical user interfaces of FIGS. 17A and 17B are examples only, and may be replaced by other types of graphical user interfaces, such as a “wizard” interface that asks the user questions to obtain the user's input data (“How long do you need to plan for?”) and provides a richer user experience than the forms of FIGS. 17A and 17B.

FIG. 18A shows a graphical user interface by which a user is provided with loan summary and analysis for a person-to-person reverse mortgage, in accordance with an embodiment of the invention. Once the user has provided input data via a graphical user interface such as that of FIG. 17A or 17B, the back end server determines a loan repayment schedule, as shown in FIG. 18B, and a loan summary and analysis 18108, based on the input data provided. A loan summary section 18109 may include the total payments to the borrower 18110, the total accrued interest 18111, the loan fee 18112, total payment fees 18113, total ending loan value 18114, total ending home value 18115, and loan-to-value (LTV) ratio 18116. In addition, in order to provide the user with guidance for the person-to-person reverse mortgage, a suggested loan terms section 18117 provides recommended maximum loan terms to stay within suitable LTV ratios, such as 70% and 90% LTV ratios. For example, a recommended loan term 18118, payment amount 18119, interest rate 18120, and home appreciation rate 18121 may be provided assuming a 70% and 90% LTV ratio. As described above, because the reverse mortgage is person-to-person, it is not subject to regulation and therefore the user may arrange for a reverse mortgage having other LTV ratios; therefore, the suggested loan terms 18117 provide guidance for prudent loan ratios. The loan summary and analysis 18108 may also include a total annual loan cost (TALC) section 18122, with a simple interest percentage 18123 and APR percentage 18124.

FIG. 18B shows a graphical user interface by which a user is provided with a repayment schedule for a person-to-person reverse mortgage, in accordance with an embodiment of the invention. Based on the user's input data, the back end server determines a loan repayment schedule 18125, which may be displayed to the user via the graphical user interface of FIG. 18B. For example, the repayment schedule 18125 may include payment dates 18126 with equity details 18127 and payment details 18128. The equity details 18127 may include home value, outstanding principal, and lender's share of home; while the payment details 18128 include the lender payment, accrued interest, fees, and payment to borrower.

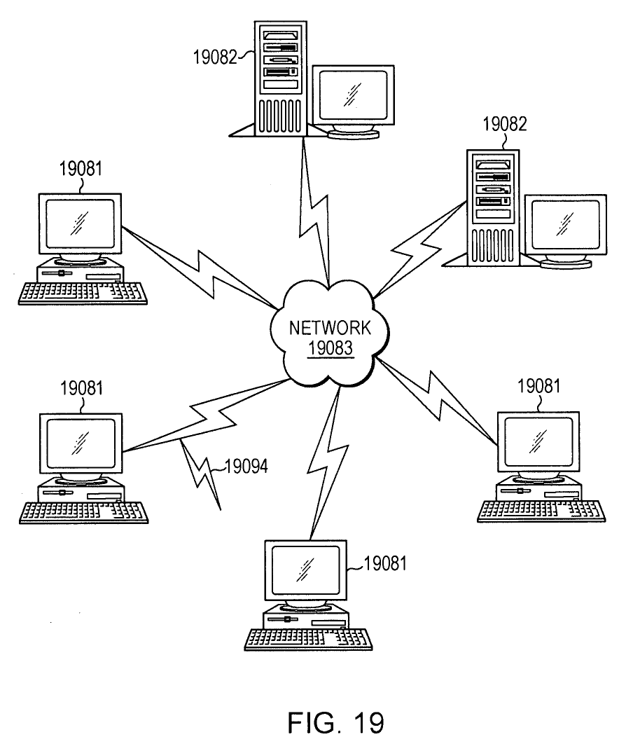

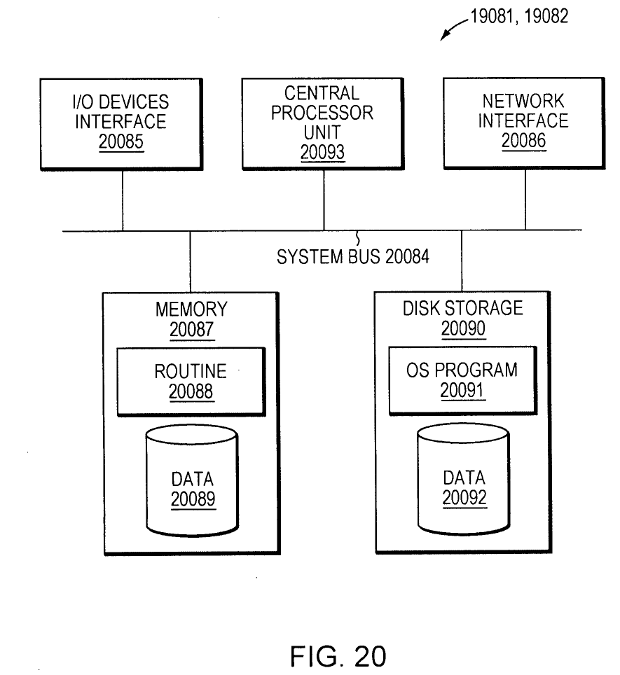

FIG. 19 illustrates a computer network or similar digital processing environment in which the present invention may be implemented.

Client computer(s)/devices 19081 and server computer(s) 19082 provide processing, storage, and input/output devices executing application programs and the like. Client computers 19081 can include, for example, the computers of the lender and borrower users of an automated system for person-to-person lending in accordance with an embodiment of the invention; and server computers 19082 can include the back end host server system(s) implementing such an automated system, and/or the server systems of a credit reporting agency to which the back end server transmits credit report data. Client computer(s)/devices 19081 can also be linked through communications network 19083 to other computing devices, including other client devices/processes 19081 and server computer(s) 19082. Communications network 19083 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 20 is a diagram of the internal structure of a computer (e.g., client processor/device 19081 or server computers 19082) in the computer system of FIG. 19. Each computer 19081, 19082 contains system bus 20084, where a bus is a set of hardware lines used for data transfer among the components of a computer or processing system. Bus 20084 is essentially a shared conduit that connects different elements of a computer system (e.g., processor, disk storage, memory, input/output ports, network ports, etc.) that enables the transfer of information between the elements. Attached to system bus 20084 is I/O device interface 20085 for connecting various input and output devices (e.g., keyboard, mouse, displays, printers, speakers, etc.) to the computer 19081, 19082. Network interface 20086 allows the computer to connect to various other devices attached to a network (e.g., network 19083 of FIG. 19). Memory 20087 provides volatile storage for computer software instructions 20088 and data 20089 used to implement an embodiment of the present invention (e.g., routines for implementing person-to-person lending, for the borrower and lender systems, the back end host server system, and/or a credit reporting agency system). Disk storage 20090 provides non-volatile storage for computer software instructions 20091 and data 20092 used to implement an embodiment of the present invention. Central processor unit 20093 is also attached to system bus 20084 and provides for the execution of computer instructions.

In one embodiment, the processor routines 20088 and data 20089 are a computer program product (generally referenced 20088), including a computer readable medium (e.g., a removable storage medium such as one or more DVD-ROM's, CD-ROM's, diskettes, tapes, etc.) that provides at least a portion of the software instructions for any aspect of the invention system (e.g. the borrower and lender user systems, the back end host server system, and/or a credit reporting agency system). Computer program product 20088 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 19094 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 20088.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 20088 is a propagation medium that the computer system 19081 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

It should be noted that software and processing modules operating on the back end host server system could be implemented via the use of any number of computer programming languages. The back end host server system may be implemented using a number of different possible computer system arrangements, including by using several servers in parallel, in a server network, or otherwise associated to implement the invention described above. Also, the database associated with the back end host server system may be implemented using any number of database systems, including using several databases in parallel or otherwise associated with the host server, and may be implementing using any number of database operating modules, languages, and techniques.

Although certain embodiments have been described herein as belonging to the first, second, third, fourth and fifth embodiments of the invention, it should be appreciated that various aspects of those embodiments may be used in combination with each other, or with other embodiments described herein, in accordance with the invention.

While this invention has been particularly shown and described with references to preferred embodiments thereof, it will be understood by those skilled in the art that various changes in form and details may be made therein without departing from the scope of the invention encompassed by the appended claims.

For example, the present invention may be implemented in a variety of computer architectures. The computer network of FIGS. 19 and 20 are for purposes of illustration and not limiting of the present invention.

What is claimed is:

1. A computer method for automating person-to-person reverse mortgages, the method comprising:
receiving from a user over a computer network a request to create a person-to-person reverse mortgage; and
transmitting a schedule for the reverse mortgage over the computer network to the user.

2. A method according to claim 1, wherein a loan-to-value (LTV) ratio for the reverse mortgage exceeds 100%.

3. A method according to claim 1, further comprising:
receiving from the user over the computer network at least one custom periodic payment amount for a payment period of the reverse mortgage;
generating a custom schedule based on the custom periodic payment amount; and
transmitting the custom schedule over the computer network to the user.

4. A method according to claim 1, further comprising:
receiving from the user over the computer network at least one of an age and a gender of at least one participant in the reverse mortgage or of the participant's spouse;
determining a recommended loan duration for the reverse mortgage based on a mortality table using at least one of the age and the gender; and
transmitting the recommended loan duration over the computer network to the user.

5. A method according to claim 1, wherein the schedule is based on a periodic cost-of-living adjustment.

6. A method according to claim 1, wherein the schedule is based on a periodic home appreciation adjustment.

7. A method according to claim 1, wherein the schedule includes payment of third party loan fees.

8. A method according to claim 7, wherein the payment of third party loan fees is due in an initial payment by at least one participant in the reverse mortgage.

9. A method according to claim 8, wherein the payment of third party loan fees is due to be repaid with interest at the completion of the reverse mortgage.

10. A method according to claim 7, wherein the payment of third party loan fees is due to be paid over a plurality of payment periods as part of payments in the payment periods.

11. A method according to claim 1, further comprising:
transmitting to the user over the computer network at least one set of recommended loan terms based on pre-determined suggested loan-to-value (LTV) ratios.

12. A carrier medium comprising computer readable code for controlling a processor to automate a person-to-person reverse mortgage by carrying out the steps of:
receiving from a user over a computer network a request to create a person-to-person reverse mortgage; and
transmitting a schedule for the reverse mortgage over the computer network to the user.
